(19) United States
(12) Patent Application Publication
(10) Pub. No.: US 2008/0097747 A1
(43) Pub. Date: Apr. 24, 2008

(54) Method and apparatus for using a language assistant

(75) Inventors: Andrew David Stonefield, Whitefish Bay, WI (US); Jorge Luis Sarmiento, El Paso, TX (US)

Correspondence Address: DEAN D. SMALL;THE SMALL PATENT LAW GROUP LLP, 611 OLIVE STREET, SUITE 1611, ST. LOUIS, MO, 63101, US

(73) Assignee: GENERAL ELECTRIC COMPANY

(21) Appl. No.: 11/584,035

(22) Filed: Oct. 20, 2006

(51) Int. Cl. G06F 17/27

(52) U.S. Cl. 704/9

(57) ABSTRACT

A medical diagnostic system comprises a processor for acquiring diagnostic imaging data of a patient. A language assistant module stores a plurality of audio files associated with a plurality of phrases. The plurality of audio files are in at least one language which is different than a predetermined primary language. A display displays a phrase menu comprising the plurality of phrases. An input is provided for selecting a first phrase from the plurality of phrases, and an audio output outputs the audio file associated with the first phrase.

### BACKGROUND OF THE INVENTION

This invention relates generally to medical diagnostic equipment, and more particularly, to using diagnostic equipment in emergency situations and circumstances.

Medical diagnostic systems are often used in emergency and trauma situations. Ultrasound, CT and X-ray are examples of diagnostic systems that may be used.

People speak many different languages, and with increasing global travel and immigration, language barriers can create a lot of confusion and lost time. When a patient and technician do not speak a common language, acquiring quality diagnostic images may be difficult. In emergency situations, there may not be time to wait for a translator. Also, a translator may not be available in some locations, such as more rural areas or at smaller facilities.

A technician or operator of the medical diagnostic system may have to rely on hand gestures or physically move the patient into different positions in order to image particular anatomy. This may be confusing and/or distressing to the patient, as well as time consuming, which may increase the danger to the patient as their injuries are not yet diagnosed. This may subsequently delay treatment for other patients.

Therefore, a need exists for improving communication between a patient and a caregiver while facilitating medical diagnostic exams. Certain embodiments of the present invention are intended to meet these needs and other objectives that will become apparent from the description and drawings set forth below.

### BRIEF DESCRIPTION OF THE INVENTION

In one embodiment, a medical diagnostic system comprises a processor for acquiring diagnostic imaging data of a patient. A language assistant module stores a plurality of audio files associated with a plurality of phrases. The plurality of audio files are in at least one language which is different than a predetermined primary language. A display displays a phrase menu comprising the plurality of phrases. An input is provided for selecting a first phrase from the plurality of phrases, and an audio output outputs the audio file associated with the first phrase.

In another embodiment, a method for communicating with a patient while acquiring diagnostic images of the patient comprises selecting a patient language from a language menu that displays a plurality of languages. The patient language is different with respect to a primary language. A first phrase is selected from a phrase menu which displays a plurality of phrases in the primary language. A first audio translation of the first phrase which is prerecorded in the patient language is played.

In another embodiment, a language assistant module comprises a display for displaying a phrase menu comprising a plurality of phrases in a primary language. At least a first language module comprises a plurality of audio files providing audio translations corresponding to the plurality of phrases. The audio translations are in a first language that is different from the primary language. A speaker outputs the audio translations.

### BRIEF DESCRIPTION OF THE DRAWINGS

FIG. 1 illustrates a block diagram of an exemplary ultrasound system formed in accordance with an embodiment of the present invention.

FIG. 2 illustrates an example of a language assistant language menu in accordance with an embodiment of the present invention.

FIG. 3 illustrates an exemplary display formed in accordance with an embodiment of the present invention.

FIG. 4 illustrates a phrase menu which may be displayed after selecting the Spanish language in accordance with an embodiment of the present invention.

FIG. 5 illustrates the language assistant module of FIG. 1 formed in accordance with an embodiment of the present invention.

FIG. 6 illustrates a method of using the language assistant module (FIG. 1) during a medical exam in accordance with an embodiment of the present invention.

FIG. 7 illustrates an alternative phrase list that also displays the written translation of each phrase in accordance with an embodiment of the present invention.

FIG. 8 illustrates an portable language assistant module formed in accordance with an embodiment of the present invention.

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block or random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

### DETAILED DESCRIPTION OF THE INVENTION

FIG. 1 illustrates a block diagram of an exemplary ultrasound system 100. The ultrasound system 100 includes a transmitter 102 that drives transducers 104 within a probe 106 to emit pulsed ultrasonic signals into a body. A variety of geometries may be used. The ultrasonic signals are back-scattered from structures in the body, like blood cells or muscular tissue, to produce echoes that return to the transducers 104. The echoes are received by a receiver 108. The received echoes are passed through a beamformer 110, which performs beamforming and outputs an RF signal. The RF signal then passes through an RF processor 112. Alternatively, the RF processor 112 may include a complex demodulator (not shown) that demodulates the RF signal to form IQ data pairs representative of the echo signals. The RF or IQ signal data may then be routed directly to an RF/IQ buffer 114 for temporary storage.

The ultrasound system 100 also includes a processor 116 to process the acquired ultrasound information (i.e., RF signal data or IQ data pairs) and prepare frames of ultrasound information for display on display system 118. The processor 116 is adapted to perform one or more processing operations according to a plurality of selectable ultrasound modalities on the acquired ultrasound information. Acquired ultrasound information may be processed in real-time during a scanning session as the echo signals are received. Additionally or alternatively, the ultrasound information may be stored temporarily in the RF/IQ buffer 114 during a scanning session and processed in less than real-time in a live or off-line operation.

The ultrasound system 100 may continuously acquire ultrasound information at a frame rate that exceeds fifty frames per second, which is the approximate perception rate of the human eye. The acquired ultrasound information is displayed on the display system 118 at a slower frame-rate. An image buffer 122 is included for storing processed frames of acquired ultrasound information that are not scheduled to be displayed immediately. In an exemplary embodiment, the image buffer 122 is of sufficient capacity to store at least several seconds worth of frames of ultrasound information. The frames of ultrasound information are stored in a manner to facilitate retrieval thereof according to its order or time of acquisition. The image buffer 122 may comprise any known data storage medium.

A user input 120 may be used to control operation of the ultrasound system 100, including, to control the input of patient data, scan parameters, a change of scan mode, and the like. This may include using voice commands provided via a microphone 124. The user input 120 may provide input capability through a keyboard, a touch screen or panel, switches, buttons, and the like. The user input 120 may be manually operable and/or voice operated via the microphone 124.

Although the ultrasound system 100 will be used in the following discussion, it should be understood that other diagnostic equipment may equally be used, such as X-ray, MR, CT and the like. A memory 126 may be provided integral with, in addition to, or separable from, the system 100. For example, the memory 126 may be a hard drive, CD Rom, DVD, flash memory, memory stick, or any other memory or memory device. A language assistant module 128 may be provided within the memory 126. The language assistant module 128 may alternatively be provided on a chip. The language assistant module 128 may be offered to a customer as an optional software package, may be included standard on the system 100, and may be downloadable from an external media source such as a hard disk, DVD, or over the internet.

The language assistant module 128 facilitates communication between an operator of the system 100 and a patient when they do not speak a common language. The operator may select a language from a plurality of languages, and then select one or more predetermined phrases which are stored in audio and/or video files 130. The phrases may be a variety of commands, requests, statements, and the like, which may require little, if any, verbal response from the patient. Audio files may be prerecorded audio translations of the phrases, while the video files may be written translations of the phrases. When the operator selects a phrase by using the user input 120, a corresponding audio translation is output by audio output 132, which may be a speaker. If a corresponding video file is available, the written translation may be displayed in the patient's language on the display system 118. Playing phrases and commands in the patient's language helps to facilitate the exam. The patient understands what the operator wants them to do, which eases the stress and confusion, and may shorten the amount of time needed for the exam.

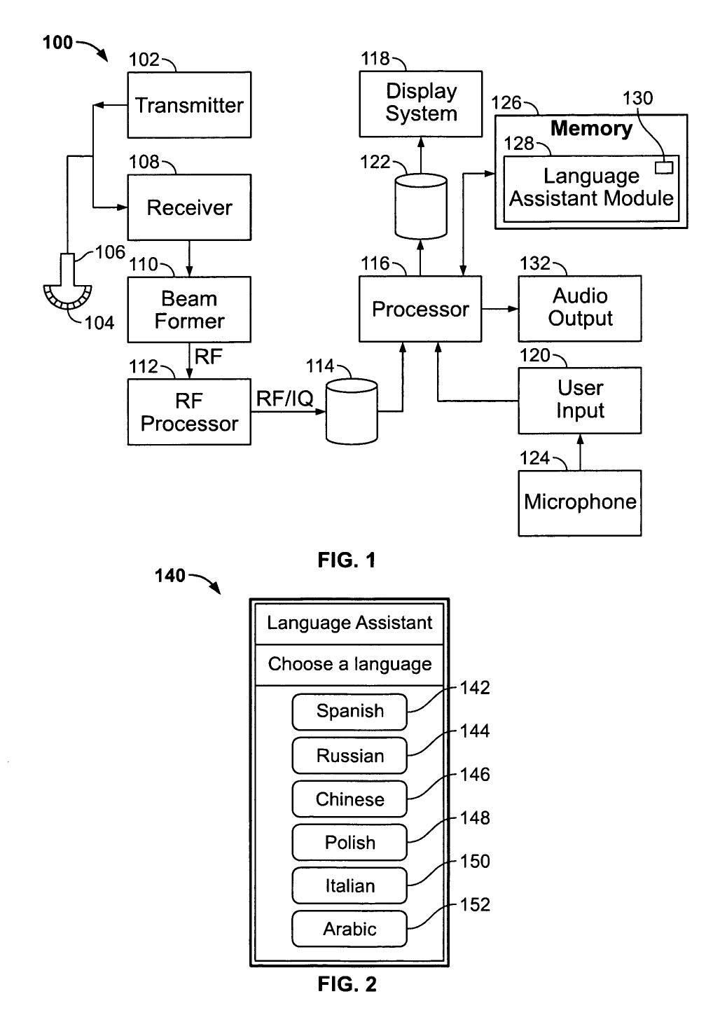

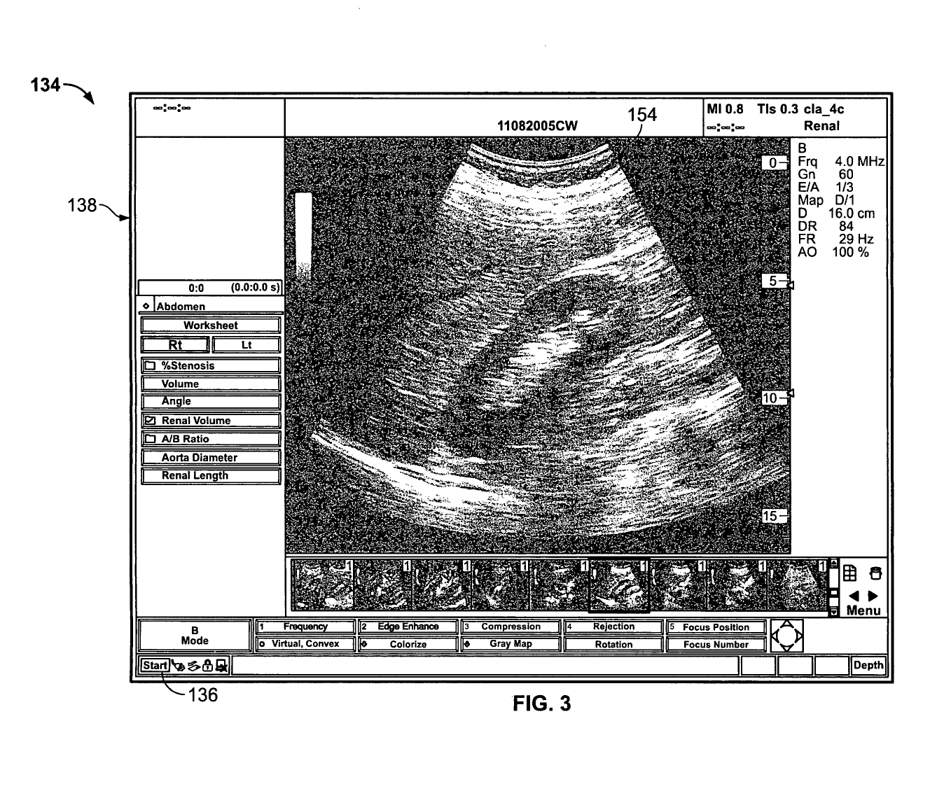

FIG. 2 illustrates an example of a language assistant language menu 140. FIG. 3 illustrates an exemplary display 134, which may be the display system 118 of FIG. 1. The language menu 140 (FIG. 2) may be selected via a start menu 136, such as by using the user input 120 or the microphone 124. The operator may select the desired language with a mouse or by touching the associated display button with their finger or a stylus if the display 134 provides touch screen capability. The language menu 140 may be displayed along a margin 138 of the display 134, therefore not obscuring diagnostic data 154.

The language menu 140 may display the languages available within selectable display buttons, such as Spanish 142, Russian 144, Chinese 146, Polish 148, Italian 150, and Arabic 152. It should be understood that other languages may be used. Also, the languages may be selected based on country or region. For example, a country which is predominantly English speaking may use English as the primary language and may desire language translations in the languages displayed in FIG. 2. Mexico, however, may use Spanish as the primary language, and thus may replace Spanish 142 with English. Also, the primary language of the system 100 may be configurable, as well as the language translations which are offered.

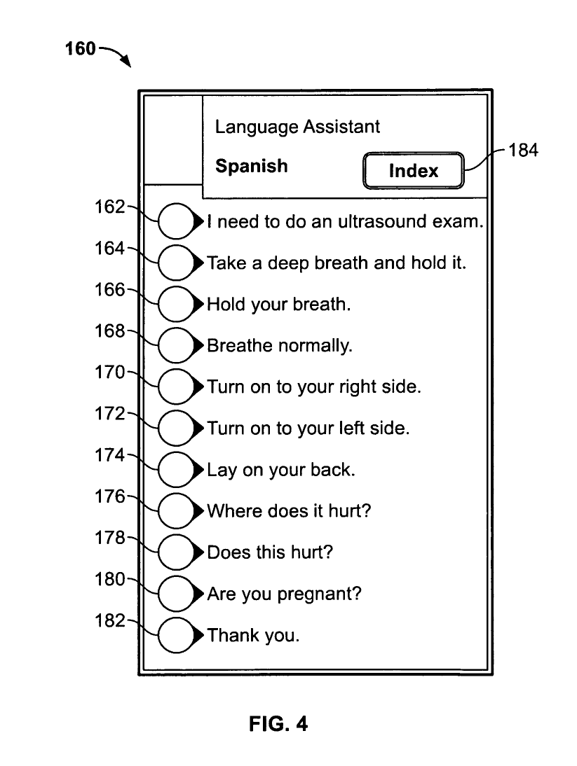

FIG. 4 illustrates a phrase menu 160 which may be displayed after selecting the Spanish 142 language button of FIG. 2. The phrase menu 160 may comprise common scanning and patient commands. Each of the phrases is associated with an audio and/or video file 130 (FIG. 1) in the language assistant module 128. First through N phrases 162-182 may be limited to information, such as telling the patient that the operator is going to do an exam; commands instructing the patient to take an action, such as hold their breath or move into a desired position; questions which can be answered through yes or no responses, such as are you pregnant; and requests which may be accomplished without verbal communication from the patient, such as by pointing at the location of their pain. The phrase menu 160 is displayed in the primary language of the area or the system 100.

It should be understood that the first through N phrases 162-182 on FIG. 4 are exemplary, and that other phrases may be used. Phrases may be provided for specific exam types, if desired. For example, an operator may desire phrases when conducting an emergency CT exam which may not be useful during an ultrasound exam. Therefore, different phrase menus 160 may be provided for different modalities, and may also be provided for different exam types within a modality.

The language menu 140 (FIG. 2) as well as the phrase menu 160 (FIG. 4) may be displayed having scroll bars (not shown) to facilitate a smaller display area. The language and phrase menus 140 and 160 may also be provided within windows that may be minimized and maximized depending upon the needs of the operator, and may be moved to other areas of the display 134 by using the user input 120.

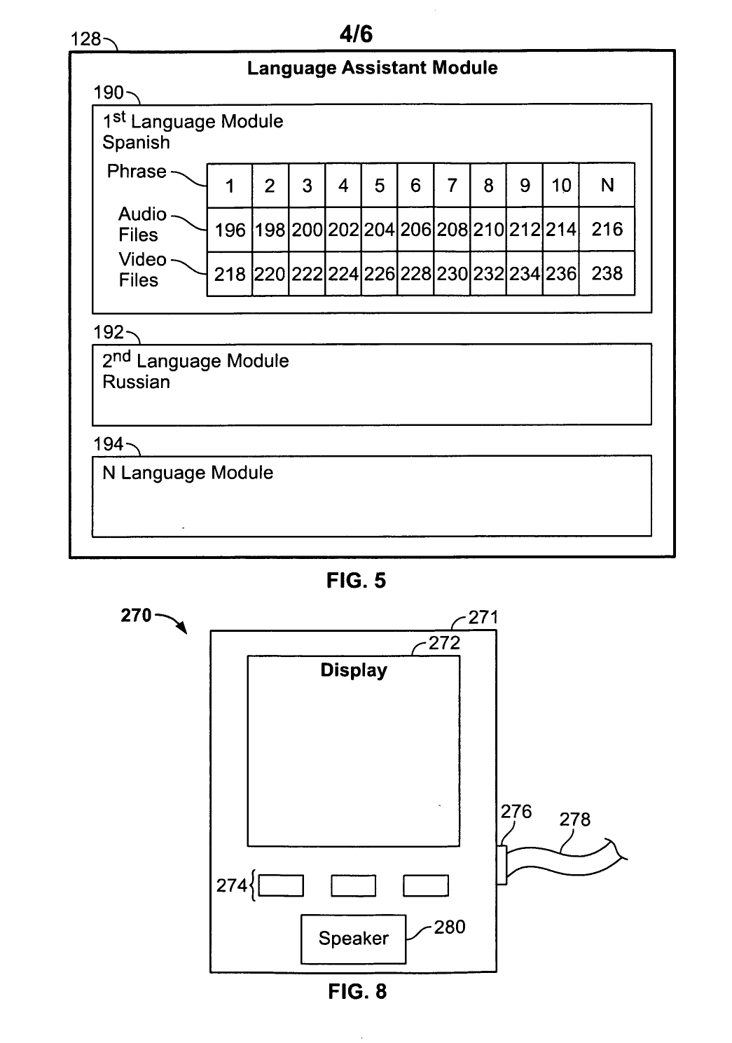

FIG. 5 illustrates the language assistant module 128 of FIG. 1. The audio and video files 130 are conceptually illustrated as comprising first, second through N language modules 190, 192, and 194, each corresponding to a different language. For example, first and second language modules 190 and 192 may correspond to the Spanish 142 and Russian 144 selections, respectively, on the language menu 140 of FIG. 2.

Within each of the first through N language modules 190-194, a plurality of audio files and optionally, associated video files, are provided. First through N audio files 196-216 and first through N video files 218-238 are associated with the first through N phrases 162-182, respectively, of FIG. 3. Individual audio files 196-216 and video files 218-238 may be prerecorded for each phrase in each different language. Optionally, each audio file may repeat the associated phrase one or more times to ensure that the patient hears the complete phrase.

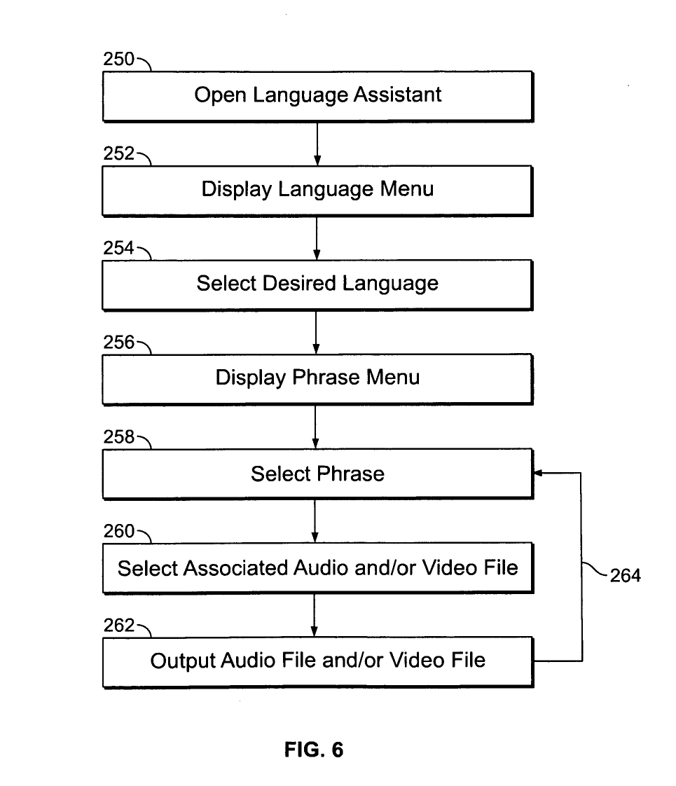

FIG. 6 illustrates a method of using the language assistant module 128 (FIG. 1) during a medical exam. By way of example, a patient may have arrived at an emergency room. The patient does not understand the primary language (English, in this example), and requires immediate medical attention. An interpreter is not available, and it is determined that the patient needs an ultrasound exam.

At 250, the operator launches or opens the language assistant, such as by selecting the option on the start menu 136 (FIG. 3). At 252, the processor 116 displays the language menu 140 on the display 134. The language menu 140 may be displayed simultaneously with the patient diagnostic data 154 as previously discussed. Optionally, if the operator has selected the wrong language or is trying to find a language the patient understands, the operator may select an index button 184 (FIG. 4) at any time, and the processor 116 will return to 252, displaying the language menu.

At 254, the operator selects the desired language from the language menu 140. By way of example, the operator may choose Spanish 142. At 256, the processor 116 displays the phrase menu 160 on the display system 118 in the primary language of the system 100 (English).

At 258, the operator may select any of the first through N phrases 162-182 (FIG. 4). By way of example, the operator may first choose the first phrase 162. At 260, the processor 116 selects the first audio file 196 (FIG. 5) within the first language module 190, and optionally, the first video file 218.

At 262, the audio output 132 outputs the audio file, which is the first phrase 162 verbally translated into Spanish, the selected language. Optionally, the processor 116 may command the display 134 to display the first video file 218 which displays a written translation of the phrase in Spanish. Therefore, if the patient is unable to hear the audio file 196, the operator may direct their attention to the display 134 as an optional communication method. The method of FIG. 6 returns to 258 in a loop via line 264, allowing the operator to select subsequent phrases to communicate with the patient.

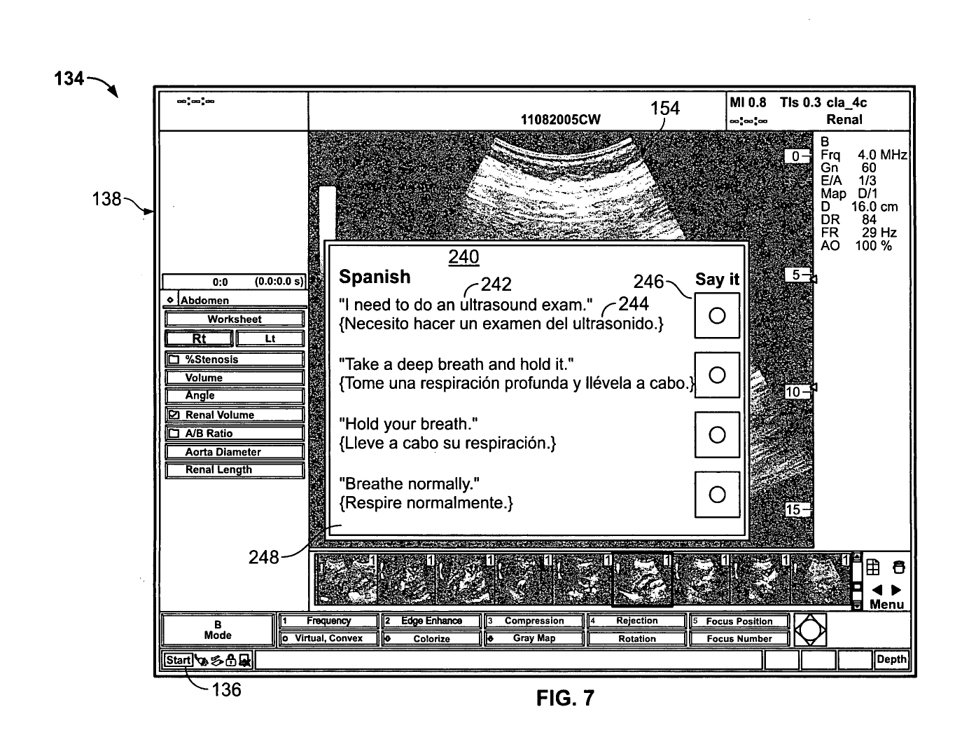

FIG. 7 illustrates an alternative phrase list 240 that also displays the written translation of each phrase. English phrases 242 are provided with corresponding written Spanish translations 244 and buttons 246 to select and play an associated audio file. The phrase list 240 may be provided in a sizable window 248, allowing the operator to minimize the window 248 during scanning and maximize the window 248 when the patient needs to read the phrase. Optionally, the phrase list 240 may also be displayed on a secondary monitor (not shown) positioned to accommodate easy viewing by the patient.

FIG. 8 illustrates an portable language assistant module 270 comprising the language translation functionality of the language assistant module 128 (FIG. 1). The portable language assistant module 270 may be provided within a housing 271 similar to a personal digital assistant or a mobile phone, and thus may be easily portable and independent of other systems. The portable language assistant module 270 may have an integrated display 272 which may accept touch input, as well as one or more user inputs 274. An input/output port 276 and cable 278 may allow the portable language assistant module 270 to interface with the ultrasound system 100 as well as other diagnostic equipment.

The language menu 140 (FIG. 2) and the phrase menu 160 (FIG. 4) may be displayed on the display 272. The operator selects the desired language and phrase(s), and the portable language assistant module 270 outputs the audio translation of the phrase(s) using speaker 280. The portable language assistant module 270 may also output the written translation of the phrase(s) on the display 272.

Optionally, when the portable language assistant module 270 is interconnected with the ultrasound system 100 (FIG. 1), the processor 116 may detect the portable language assistant module 270 and allow the operator to access the translation files via the user input 120, the audio output 132, and the display system 118. Optionally, portable the portable language assistant module 270 may be provided without the display 272 and/or speaker 280, and be operable by plugging directly into the system 100, such as a flash memory or other portable memory device.

A technical effect is the ability to communicate more easily between the operator of the diagnostic equipment and the patient when they do not speak a common language. The language assistant module 128 provides a plurality of phrases in a plurality of different languages. The operator may play audio translations and display written translations of the phrases in the patient's language.

While the invention has been described in terms of various specific embodiments, those skilled in the art will recognize that the invention can be practiced with modification within the spirit and scope of the claims.

What is claimed is:

1. A medical diagnostic system, comprising:
a processor for acquiring diagnostic imaging data of a patient;
a language assistant module storing a plurality of audio files associated with a plurality of phrases, the plurality of audio files being in at least one language which is different than a predetermined primary language;
a display displaying a phrase menu comprising the plurality of phrases;
an input for selecting a first phrase from the plurality of phrases; and
an audio output for outputting the audio file associated with the first phrase.

2. The system of claim 1, the phrase menu further comprising a written set of the plurality of phrases in the primary language.

3. The system of claim 1, the plurality of phrases further comprising at least two phrases that are different with respect to each other.

4. The system of claim 1, wherein the display further displaying the phrase menu and the diagnostic imaging data simultaneously.

5. The system of claim 1, the language assistant module further comprising a plurality of language modules, each of the plurality of language modules comprising at least one of a plurality of audio files and a plurality of video files, the plurality of audio files and the plurality of video files each being associated with at least a subset of the plurality of phrases.

6. The system of claim 1, the language assistant module further comprising a plurality of video files associated with the plurality of phrases, the display displaying the plurality of video files and the plurality of phrases simultaneously.

7. The system of claim 1, wherein the language assistant module is one of integrated with the medical diagnostic equipment and portable separate from the medical diagnostic equipment.

8. The system of claim 1, wherein the diagnostic imaging data being at least one of ultrasound data, CT data, X-ray data, and MR data.

9. The system of claim 1, further comprising a memory storing the language assistant module, the memory being one of integrated with the processor and separable from the processor.

10. A method for communicating with a patient while acquiring diagnostic images of the patient, comprising:
selecting a patient language from a language menu displaying a plurality of languages, the patient language being different with respect to a primary language;
selecting a first phrase from a phrase menu, the phrase menu displaying a plurality of phrases in the primary language; and
playing a first audio translation of the first phrase, the first audio translation being prerecorded in the patient language.

11. The method of claim 10, further comprising displaying the plurality of phrases in the patient language proximate to the plurality of phrases being displayed in the primary language.

12. The method of claim 10, further comprising:
acquiring diagnostic imaging data of the patient; and
displaying the diagnostic imaging data and the phrase menu simultaneously.

13. The method of claim 10, further comprising:
storing a first set of audio translations associated with the plurality of phrases in a first language; and
storing a second set of audio translations associated with the plurality of phrases in a second language, the first and second languages and the primary language being different with respect to each other.

14. The method of claim 10, further comprising:
storing a first set of video files associated with the plurality of phrases in a first language; and
storing a second set of video files associated with the plurality of phrases in a second language, the first and second sets of video files providing written translations of associated phrases in the first and second languages, the first and second languages and the primary language being different with respect to each other.

15. The method of claim 10, further comprising displaying a written translation of the first phrase in the patient language.

16. A language assistant module, comprising:
a display for displaying a phrase menu comprising a plurality of phrases in a primary language;
at least a first language module comprising a plurality of audio files providing audio translations corresponding to the plurality of phrases, the audio translations being in a first language that is different from the primary language; and
a speaker for outputting the audio translations.

17. The language assistant module of claim 16, further comprising:
a second language module comprising a plurality of audio files providing audio translations of the plurality of phrases, the audio translations being in a second language that is different from the primary and first languages; and
the display further displaying a language menu comprising the first and second languages.

18. The language assistant module of claim 16, further comprising:
the at least a first language module comprising a plurality of video files associated with the plurality of phrases, the video files providing written translations in the first language corresponding to the plurality of phrases; and
the display further displaying the plurality of phrases in the primary language proximate to an associated written translation in the first language.

19. The language assistant module of claim 16, further comprising:
an input/output port for interconnecting with an external system; and
a processor for accepting input from the external system and transferring the audio translations through the input/output port to the external system.

20. The language assistant module of claim 16, the display comprising a touchscreen technology.
